(19) United States
(12) Patent Application Publication
(10) Pub. No.: US 2009/0129785 A1
(43) Pub. Date: May 21, 2009

(54) OPTICAL AMPLIFYING DEVICE AND OPTICAL TRANSMISSION SYSTEM

(75) Inventor: Yuki MURAKAMI, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/257,045

(22) Filed: Oct. 23, 2008

(30) Foreign Application Priority Data
Nov. 19, 2007 (JP) 2007-299365

(51) Int. Cl. H04B 10/12; H01S 3/00; H04B 10/00

(52) U.S. Cl. 398/160; 359/337.2; 359/341.41

(57) ABSTRACT

An optical amplifying device includes an amplifying unit for amplifying an optical signal using stimulated emission; a filter unit for attenuating at least part of a band of an output of the amplifying unit other than a main signal band of the optical signal; and an amplification control unit for controlling the amplifying unit on the basis of an output of the filter unit, the amplification control unit having, as a mode for controlling the amplifying unit, an amplified spontaneous emission output mode for causing the amplifying unit to operate, with the optical signal not being input to the amplifying unit, and for causing the filter unit to filter the amplified spontaneous emission output from the amplifying unit and to output the filtered amplified spontaneous emission to outside.

### CROSS-REFERENCE TO RELATED APPLICATIONS

This application is based upon and claims the benefit of priority of Japanese Patent Application No. 2007-299365, filed on Nov. 19, 2007, the entire contents of which are incorporated herein by reference.

### FIELD

The embodiments discussed herein are directed to a device for amplifying optical signals and an optical transmission system employing amplification of optical signals.

### BACKGROUND

Optical signals have been amplified using stimulated emission in optical transmission systems, such as wavelength division multiplexing (WDM) devices. Rare-earth-element-containing optical amplifiers employed in such optical transmission systems collectively amplify wavelength-division multiplexed signals in a main signal band using the stimulated emission. At this time, spontaneous emission having a phase not correlated with the main signals is also generated at the same time. The spontaneous emission is amplified in the optical amplifiers along with the main signals, whereby an optical noise called amplified spontaneous emission (ASE) is generated.

FIG. 1 is a diagram showing a configuration of a general optical amplifier according to the related art. As shown in FIG. 1, an optical amplifier includes an input-monitoring unit for monitoring an input power, an output-monitoring unit for monitoring an output power, a fiber portion containing a rare-earth element, and a pump laser for pumping the rare-earth element.

Types of optical amplifiers employed in an optical transmission system are mainly categorized into a transmitting amplifier for outputting a signal to a transmission path and a receiving amplifier for amplifying a signal supplied from the transmission path. Optical amplifiers have operational modes, namely, an automatic gain control (AGC) mode in which gain (ratio) of an output signal to an input signal is controlled to be constant and an automatic level control (ALC) mode in which the output power with respect to a given input signal is controlled to be constant. In the AGC mode, differences between target gain and operation gain monitored by the input and output monitoring units are calculated and a feedback control operation is performed on the pump laser. In the ALC mode, the feedback control operation is performed on the pump laser so that the output power monitored by the output monitoring unit becomes constant.

If an optical amplifier serves as a transmitting amplifier, an input signal fed to the transmitting amplifier is output from an optical transmitter or the like. The transmitting amplifier can operate in the AGC mode using previously set target gain. On the other hand, if an optical amplifier serves a relay amplifier or a receiving amplifier, the amplifier operates in the ALC mode during activation to guarantee a path loss, which differs for each line, and sets gain that provides a predetermined output power level. The amplifier then operates in the AGC mode using the set gain.

In both of the AGC mode and the ALC mode, since the gain is infinite when no signals are input, input of optical signals is necessary for a stable operation. Accordingly, the optical amplifier is generally controlled to stop operating when no signals are input thereto. Alternatively, the optical amplifier is controlled to wait for the input while the pump laser is being driven by low-level current.

However, traffic does not propagate in an optical transmission system employing a redundant configuration. Accordingly, target gain of a receiving amplifier has to be set when no optical signals are input thereto. An example case is discussed below. A system shown in FIG. 2 has a redundant configuration. More specifically, a counterclockwise path is a currently used line, whereas a clockwise path is a redundant line. During a normal operation, traffic is transmitted via a path constituted by nodes 1, 4, and 3 in this order. Since traffic does not propagate through the redundant line during the normal operation, no signals are input to an optical amplifier of the redundant line. If a trouble occurs in a line between the nodes 4 and 3, for example, the path is switched to a line constituted by the nodes 1, 4, 1, 2, and 3 in this order.

In a system according to the related art, only after an optical amplifier of the redundant line receives an input signal of real traffic, the optical amplifier starts setting target gain. Thus, it undesirably takes some time to pass a main signal after the switching of the line in the system according to the related art.

To solve this problem, for example, Japanese Unexamined Patent Application Publication No. 2004-23437 discloses a gain setting method (ASE-employing activation method) using amplified spontaneous emission (ASE). In the ASE-employing activation method, gain of a receiving amplifier is set using, as an input light source, ASE light that is generated by compulsorily making a pump laser emit the light when no signals are input to the optical amplifier.

FIG. 3 shows an example of a configuration of a transmission system according to the related art. A node 1 is a transmitting node for outputting an optical signal to a line. A node 2 is a receiving node for optically amplifying the signal input from the line and reproducing the signal. When the ASE-employing activation operation is performed in this transmission system, a control unit of the node 2 sends an ASE output request to the node 1.

Upon receiving the ASE output request, the transmitting amplifier starts outputting the ASE and controls the output power to reach a predetermined level (corresponding to one channel of the main signal, for example). Once output power of the transmitting amplifier reaches the predetermined level, a control unit of the node 1 sends an ASE stabilization notification to the node 2. Upon an input power reaching a predetermined threshold, the receiving amplifier starts operating in an ALC mode. Once the output power of the receiving amplifier reaches a predetermined level after the reception of the ASE stabilization notification, the control unit of the node 2 sets target gain used in the AGC mode.

After the completion of the gain setting, the control unit of the node 2 shuts down the receiving amplifier. The control unit of the node 2 then sends an ASE termination request to the node 1. Upon receiving the ASE termination request, the control unit of the node 1 shuts down the transmitting amplifier. After confirming input of a predetermined optical power level, the control unit of the node 1 cancels the shutdown state of the transmitting amplifier and causes the transmitting amplifier to operate in the AGC mode. After confirming input of a predetermined optical power level, the control unit of the node 2 causes the receiving amplifier to operate in the AGC mode using the target gain set in the ASE-employing activation operation.

In the ASE-employing activation operation according to the related art, it is assumed that wideband amplified spontaneous emission reaches the receiving amplifier after losing the level equivalent to a transmission path loss while maintaining a profile thereof. However, if a medium having a loss characteristic depending on a wavelength exists in a transmission path, the power of the ASE reaching the receiving amplifier becomes lower than an expected value. As a result, the receiving amplifier operates in the ALC mode with the power lower than it is expected and sets target gain of the AGC mode. Thus, the operation gain exceeding an optimum level is undesirably set for an actual main signal band.

Suppose that a level of the ASE in a band other than a main signal band (non-main-signal band) drops by 10 dB in addition to a transmission path loss of 20 dB, for example. At this time, the receiving amplifier sets target gain while recognizing that the transmission path loss is 30 dB. When the receiving amplifier operates in the AGC mode after the activation of the line, the set gain exceeds the necessary gain of 20 dB by 10 dB. Accordingly, a deviation from an optimum input point of an optical receiver is caused and an optimum transmission characteristic is not obtained. To avoid this situation, the receiving amplifier has to be temporarily switched into the ALC mode from the AGC mode after the activation of the line to reconfigure target gain that gives a predetermined output power corresponding to the number of operating wavelengths. When a feedback step of the ALC mode is 0.1 dB/second, it takes 100 seconds to achieve the optimum target gain in the above-described case.

Accordingly, in the ASE-employing activation operation according to the related art, target gain for compensating a path loss cannot be set accurately and activation of a line takes some time due to the necessity of reconfiguration of the target gain.

### SUMMARY

According to an aspect of an embodiment, an optical amplifying device includes an amplifying unit for amplifying an optical signal using stimulated emission, a filter unit for attenuating at least part of a band of an output of the amplifying unit other than a main signal band of the optical signal, and an amplification control unit for controlling the amplifying unit on the basis of an output of the filter unit, the amplification control unit has an amplified spontaneous emission output mode for causing the amplifying unit to operate without the optical signal being input to the amplifying unit, and for causing the filter unit to filter the amplified spontaneous emission output from the amplifying unit and to output the filtered amplified spontaneous emission.

According to an aspect of an embodiment, an optical transmission system includes: a transmitting node for amplifying and transmitting an optical signal, the transmitting node including an amplifying unit for amplifying the optical signal using stimulated emission, a filter unit for attenuating at least part of a band of an output of the amplifying unit other than a main signal band of the optical signal, and an amplification control unit for controlling the amplifying unit on the basis of an output of the filter unit, the amplification control unit having, as a mode for controlling the amplifying unit, an amplified spontaneous emission output mode for causing the amplifying unit to operate, with the optical signal not being input to the amplifying unit, and for causing the filter unit to filter the amplified spontaneous emission output from the amplifying unit and to output the filtered amplified spontaneous emission to outside; and a receiving node for receiving and amplifying the optical signal transmitted from the transmitting node, the receiving node having, as amplification control modes, an automatic level control mode for controlling an amplified output level to be constant and an automatic gain control mode for controlling amplification gain to be constant; wherein control information is transmitted and received between the transmitting node and the receiving node, and wherein, when a line is activated in the optical transmission system, the transmitting node and the receiving node operate in the amplified spontaneous emission output mode and the automatic level control mode, respectively, to set target gain of the amplifying unit of the receiving node using the amplified spontaneous emission from which extra optical signals in a non-main-signal band are removed.

### BRIEF DESCRIPTION OF DRAWINGS

FIG. 1 is a configuration diagram illustrating a configuration of an optical amplifier according to the related art;

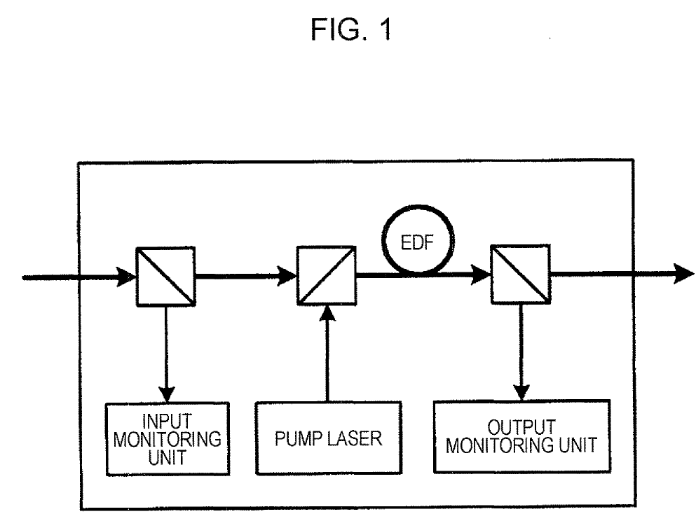

FIG. 2 is an explanatory diagram illustrating an optical transmission system having a redundant configuration;

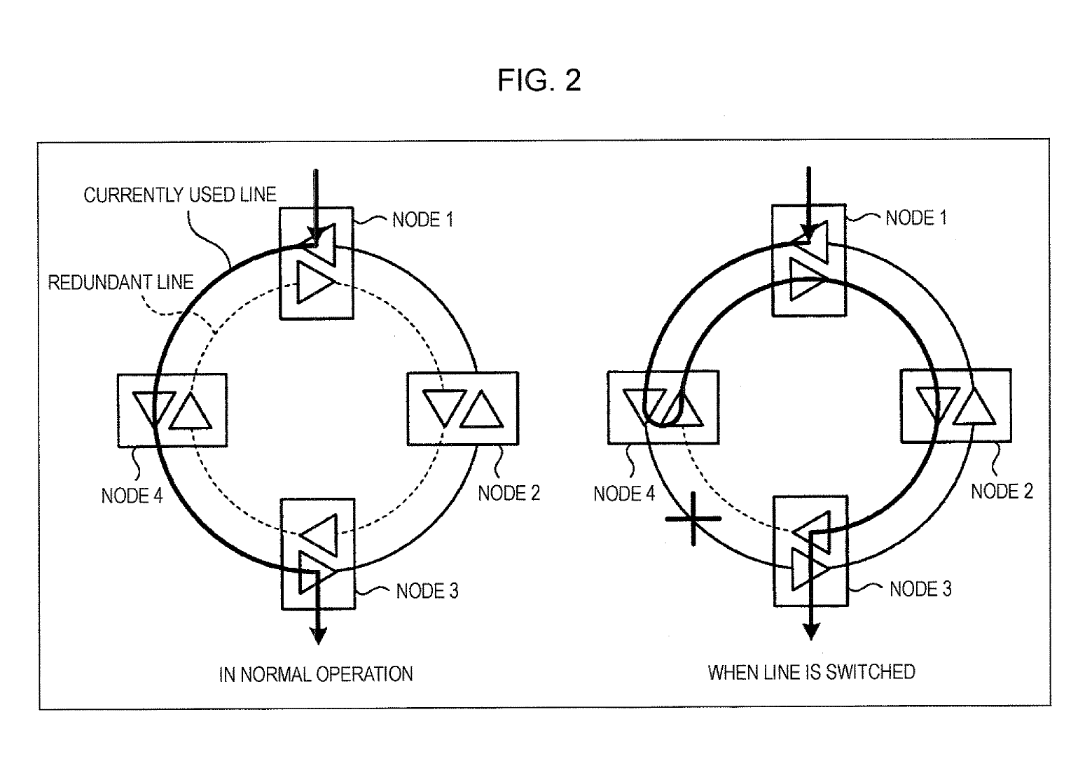

FIG. 3 is a configuration diagram illustrating a configuration of an optical transmission system according to the related art;

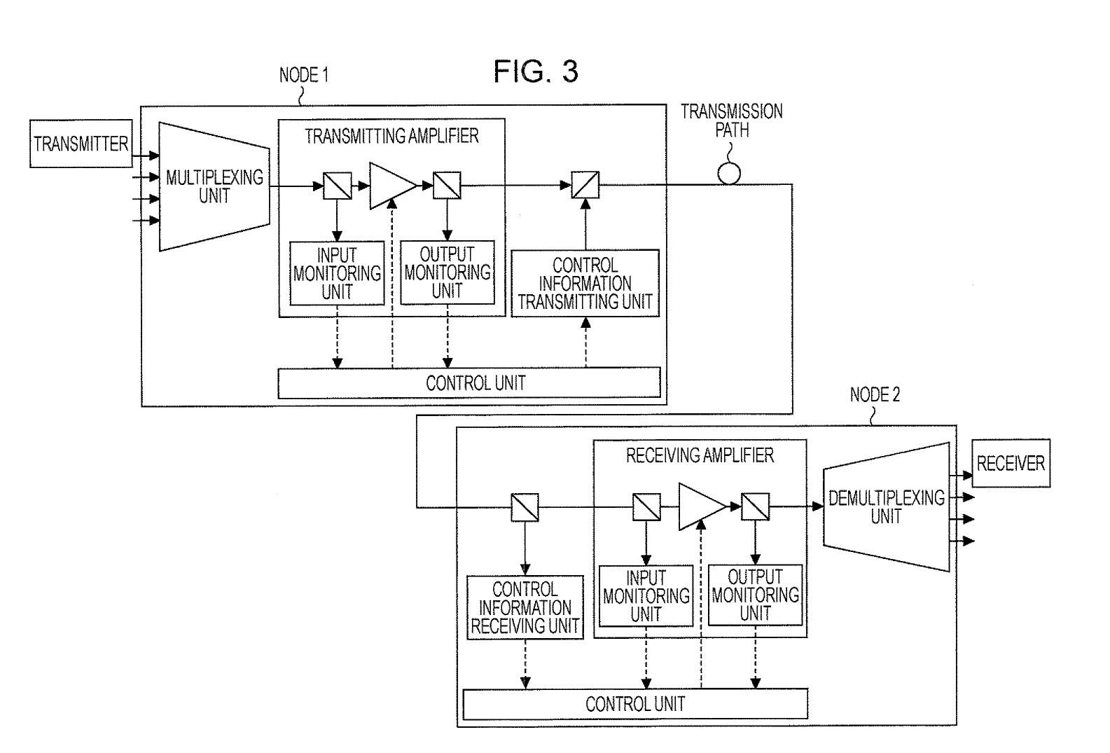

FIG. 4 is an explanatory diagram illustrating an embodiment;

FIG. 5 is a diagram illustrating a configuration of an optical amplifier according to an embodiment (pattern 1);

FIG. 6 is a diagram illustrating a configuration of an optical amplifier according to an embodiment (pattern 2);

FIG. 7 is a diagram illustrating a configuration of an optical amplifier according to an embodiment (pattern 3);

FIG. 8 is a diagram illustrating a configuration of an optical transmission system according to an embodiment (pattern 1);

FIG. 9 is an explanatory diagram illustrating an example of a line activation using ASE-employing activation (pattern 1);

FIG. 10 is a configuration diagram illustrating a configuration of an optical transmission system according to an embodiment (pattern 2); and

FIG. 11 is an explanatory diagram illustrating an example of a line activation using ASE-employing activation (pattern 2).

### DESCRIPTION OF EMBODIMENTS

Embodiments of an optical amplifying device and an optical transmission system will be described in detail below on the basis of the drawings.

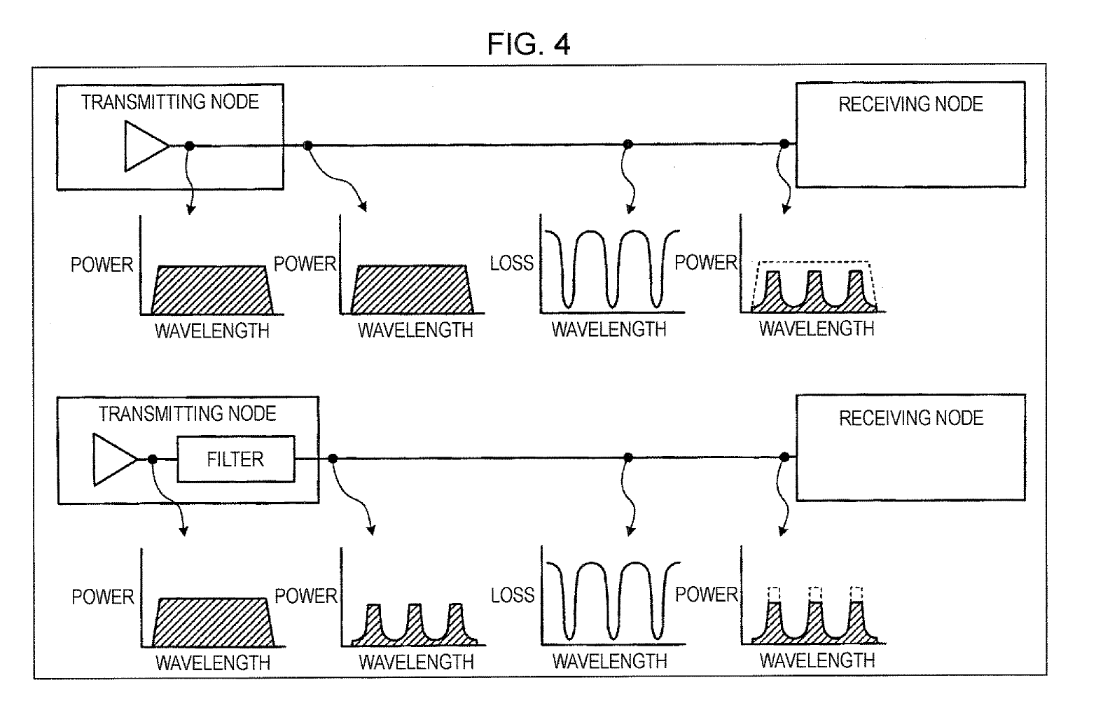

Referring first to FIG. 4, an embodiment will be described. In an optical amplifying device according to an embodiment, a filter for removing optical signals in a band other than a main signal band (a band used as main signals) is applied to spontaneous emission to obtain a pseudo main signal. Gain of a receiving node is determined on the basis of a path loss of this pseudo main signal, whereby a value closer to gain necessary for amplification of an optical signal is obtained.

As shown in FIG. 4, amplified spontaneous emission output from an optical amplifier maintains an original wideband profile. On the other hand, a medium or a device arranged in a transmission path may have a loss characteristic that depends on a wavelength. The medium or the device arranged in the path is designed to have a relatively low loss characteristic in a main signal band of an optical signal. However, the medium or the device may have a high loss characteristic in a band other than the main signal band (hereinafter, referred to as a non-main-signal band).

In this case, if amplified spontaneous emission output from the optical amplifier is transmitted to a receiving node through a transmission path as it is, the power of signals in the non-main-signal band significantly drops. Accordingly when the receiving node determines amplification gain by comparing the power (a size of a profile) of the amplified spontaneous emission output from the transmitting node with the power (a size of a profile) of the amplified spontaneous emission exposed to the path loss and reaching the receiving node, gain compensating a large loss in the non-main-signal band is calculated. Accordingly, the gain exceeding a level necessary for compensating the loss at the time of transmission of an actual optical signal is set in the receiving node.

On the other hand, in this embodiment, a filter for removing signals in the non-main-signal band is applied to the amplified spontaneous emission output from the optical amplifier to create a pseudo main signal. The transmitting node then transmits this pseudo main signal. The path loss is caused only in the main signal band as in the case of the actual optical signal transmission. Accordingly, it is possible to accurately determine a loss caused during transmission of an actual optical signal and appropriately set gain necessary for compensating the loss in the receiving node.

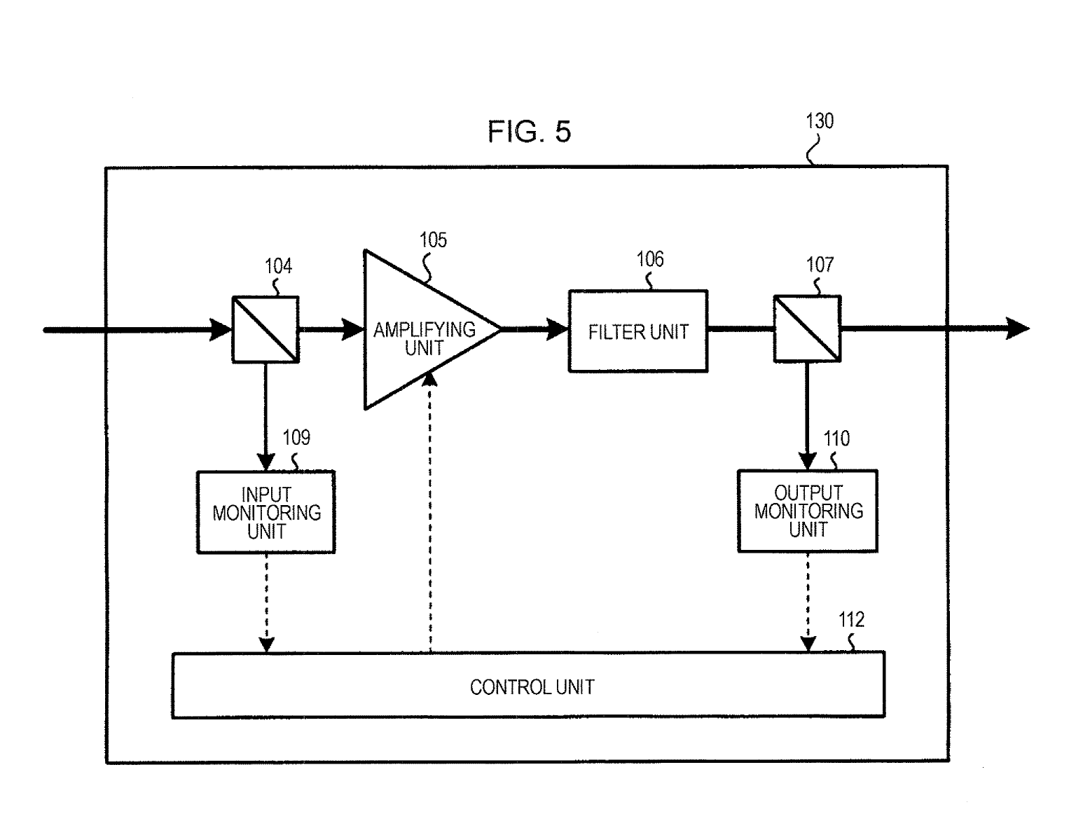

FIG. 5 is a diagram illustrating a configuration of an optical amplifier according to an embodiment. A signal input to an optical amplifier 130 is optically amplified by an amplifying unit 105 and output to a filter unit 106 arranged on the output side. The filter unit 106 removes optical signals in the non-main-signal band and outputs the signals to a transmission path. An input monitoring unit 109 and an output monitoring unit 110 monitor optical signals split by optical couplers 104 and 107, whereby the input and output power levels of the amplifying unit 105 are monitored, respectively. A control unit 112 controls the amplifying unit 105 on the basis of the power levels monitored by the input monitoring unit 109 and the output monitoring unit 110 in a manner described below.

First, in an ASE mode, the control unit 112 sends an ASE output instruction to the amplifying unit 105. The control unit 112 controls the amplifying unit 105 so that the output power level of the filtered signal, output to the transmission path, monitored by the output monitoring unit 110 indicates a predetermined value. During a normal operation, the control unit 112 controls the amplifying unit 105 in an AGC mode to set gain of the amplifying unit 1051 rather than the optical power levels monitored by the input monitoring unit 109 and the output monitoring unit 110, to a constant level. Alternatively, the control unit 112 controls the amplifying unit 105 in an ALC mode to set the optical power monitored by the output monitoring unit 110 to a predetermined value corresponding to a number of operating wavelengths.

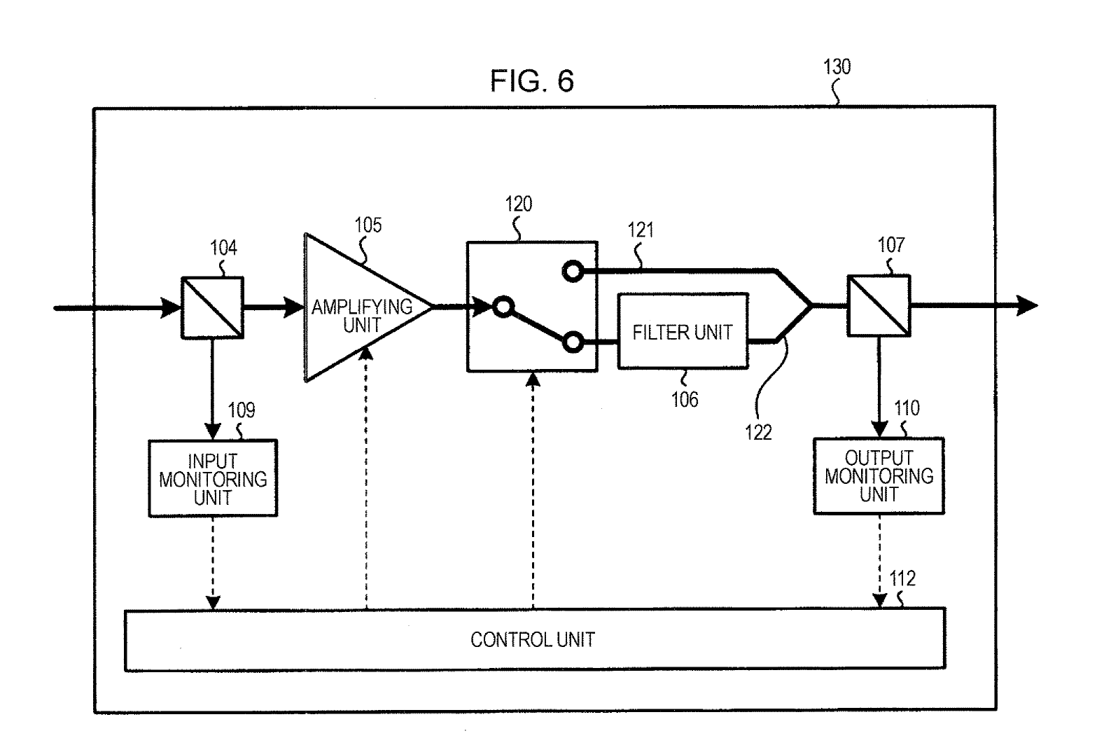

In addition, as shown in FIG. 6, different paths may be selected at time of a normal operation and activation. An optical amplifier 130 shown in FIG. 6 includes a normal path 121 for outputting a signal output from an amplifying unit 105 to a line as is, an activation path 122 including a filter unit 106 for removing optical signals in a non-main-signal band, and a path switching unit 120 for selecting one of the normal path 121 and the activation path 122.

In this configuration, a control unit 112 selects the activation path 122 in the ASE mode and sends an ASE output instruction to the amplifying unit 105. The ASE output from the amplifying unit 105 is filtered by the filter unit 106 on the activation path 122 and is output to an output monitoring unit 110. The output monitoring unit 110 performs a control operation to create a pseudo main signal having a predetermined optical power level. On the other hand, during a normal operation, the control unit 112 selects the normal path 121. The control unit 112 performs the control operation in the AGC mode so that gain of the amplifying unit 105, rather than the optical power levels monitored by the input and output monitoring units 109 and 110, is set to a constant value. Alternatively, the control unit 112 controls the amplifying unit 105 in an ALC mode to set the optical power level monitored by the output monitoring unit 110 to a predetermined value corresponding to the number of operating wavelengths.

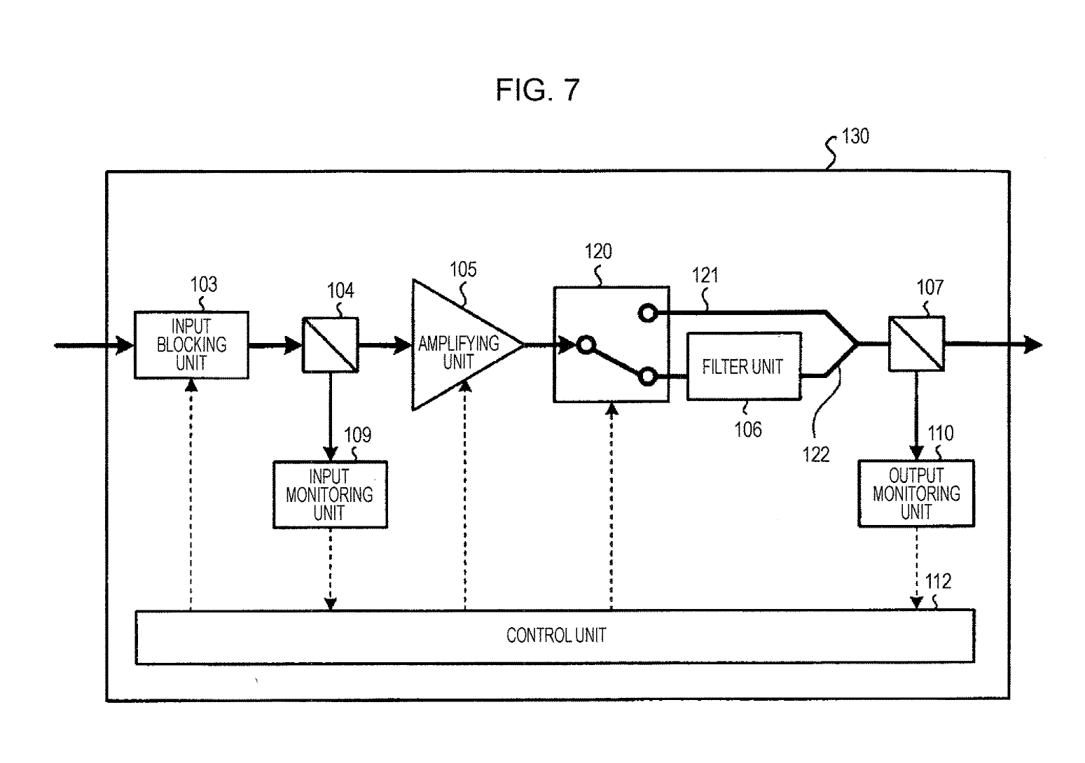

Additionally, as shown in FIG. 7, an input signal to an amplifying unit 105 may be blocked in an ASE mode. In a configuration shown in FIG. 7, an optical amplifier 130 has an input blocking unit 103 on an input side of an amplifying unit 105. In the ASE mode, a control unit 112 causes the input blocking unit 103 to block an input signal (a blocked state) in order to stabilize an output signal with the input signal to the amplifying unit 105 being completely blocked. During a normal operation, the control unit 112 causes the input blocking unit 103 to pass the input signal (a released state) so as to supply the input signal to the amplifying unit 105.

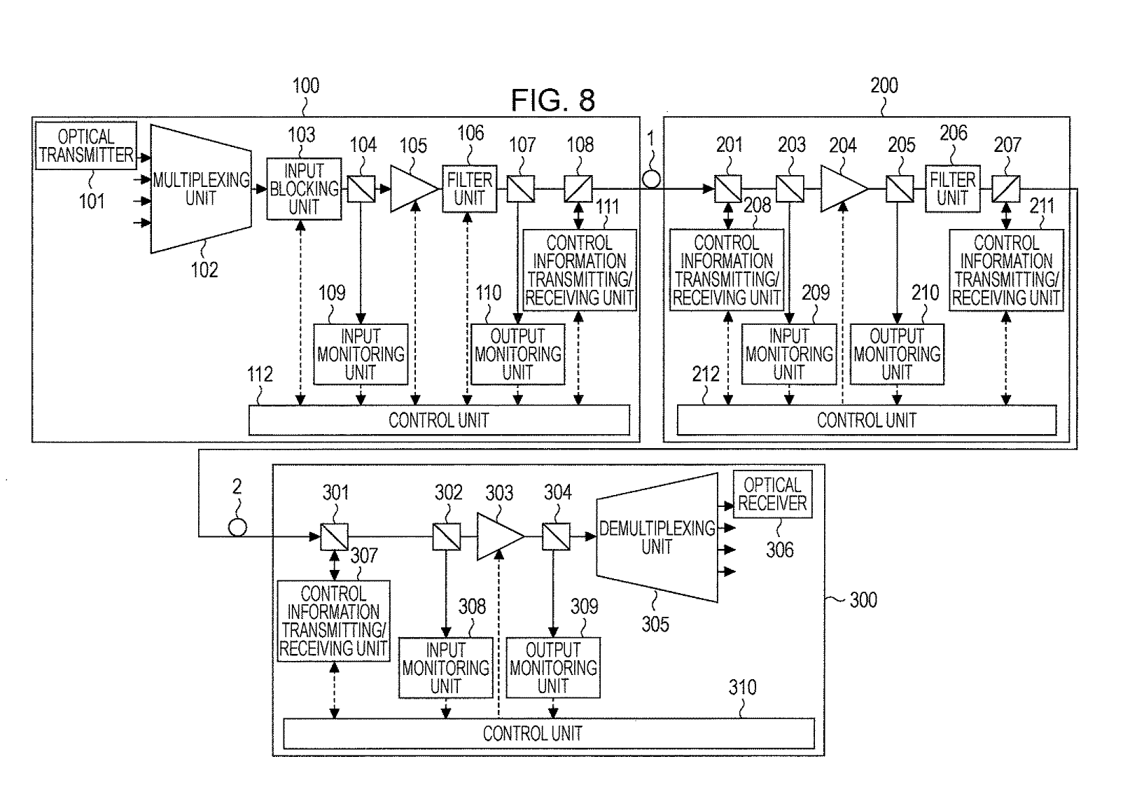

FIG. 8 shows an example of a configuration of an optical transmission system employing optical amplifiers. In a transmitting node 100 shown in FIG. 8, a multiplexing unit 102 performs wavelength-division multiplexing on optical signals of respective channels transmitted from an optical transmitter 101. The multiplexed WDM signal is optically amplified by a transmitting amplifying unit 105 and is output to a transmission path 1. In a relay node 200, the input signal fed from the transmission path 1 is reproduced and relayed using a relay amplifying unit 204 and is output to a transmission path 2.

In a receiving node 300, a receiving amplifying unit 303 amplifies the input signal fed from the transmission path 2. The signal is then demultiplexed to optical signals of a single wavelength by a demultiplexing unit 305. An optical receiver 306 terminally receives the demultiplexed optical signals. Here, the receiving amplifying unit 303 or the relay amplifying unit 204 can operate in the ALC mode for setting the output power constant and in the AGC mode for setting the output gain constant.

Additionally, the transmitting, relay, and receiving nodes include control information transmitting/receiving units 111, 208 and 211, and 307 for transmitting/receiving control information, respectively. Coupling/splitting units 108, 201 and 207, 301 and 304 for transmitting the control signal to the transmission path are also included.

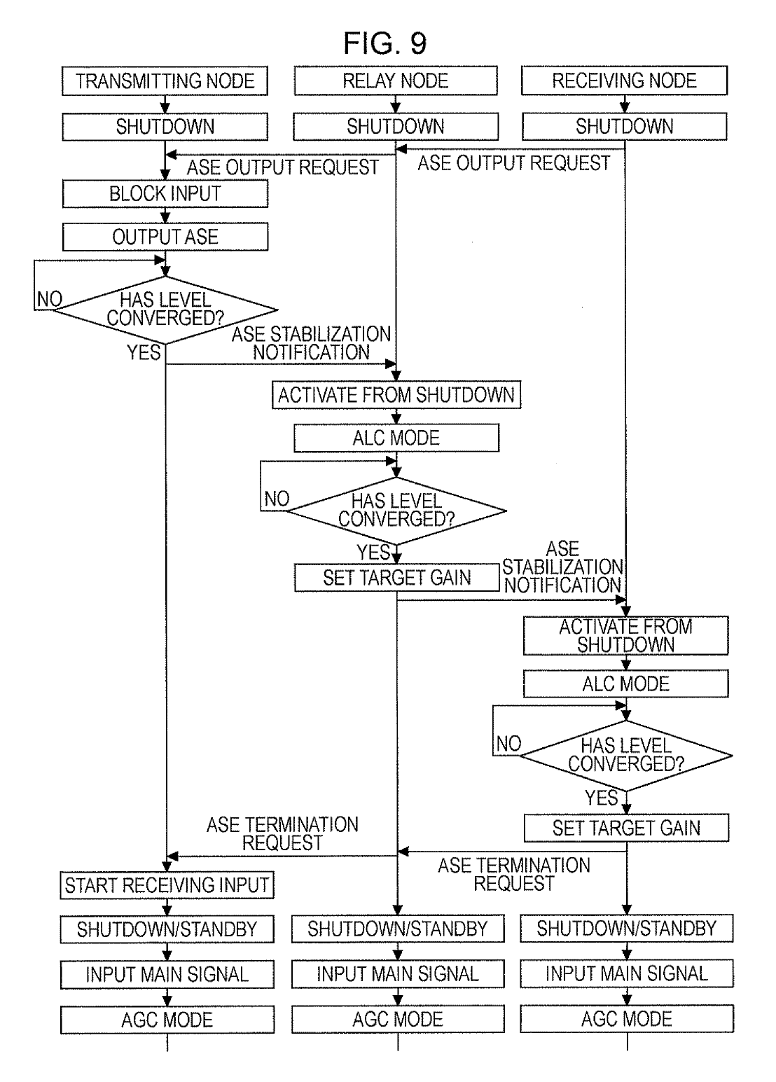

An example of a line activation method using ASE-employing activation is described below using FIG. 9. At the time of initial line activation, the receiving node 300 transmits an ASE output request to the relay node 200 on an upstream side.

Upon receiving this request, the relay node 200 relays the ASE output request to the transmitting node 100 on an upstream side. Upon receiving the ASE output request, the transmitting node 100 brings the input breaking unit 103 into a blocked state. The transmitting node 100 then causes the amplifying unit 105 to operate in an ASE mode.

Upon a power level monitored by the output monitoring unit 110 reaching a predetermined value, the transmitting node 100 transmits an ASE stabilization notification to the relay node 200 on a downstream side. In response to reception of this signal, the relay node 200 causes the relay amplifier 204 to operate in an ALC mode using a pseudo input signal fed from the transmitting node 100. The relay node 200 performs a control operation so that the power level monitored by the output monitoring unit 210 reaches a predetermined value.

The relay node 200 includes a filter unit for filtering signals output at the time of the activation of a line to remove optical signals in a non-main-signal band or an activation path having the filter unit. Accordingly, the signal output from the relay node 200 is also a pseudo main signal as in the case of the signal from the transmitting node 100.

After convergence of the output signal, a control unit 212 of the relay node 200 stores the gain of the relay amplifying unit 204 obtained at that time as target gain of the AGC mode. After the completion of setting of the target gain of the following node, the relay node 200 transmits the ASE stabilization notification to the receiving node 300 on the downstream side.

Upon receiving this signal, the receiving node 300 causes the receiving amplifying unit 303 to operate in the ALC mode. The receiving node 300 performs a control operation so that the power level monitored by an output monitoring unit 309 reaches a predetermined value to set target gain as in the case of the relay node 200. After setting the target gain, the receiving node 300 transmits an ASE termination request to the relay node 200 on the upstream side. The relay node 200 relays the ASE termination request to the transmitting node 100 on the upstream side. After the completion of the ASE-employing activation, the transmitting node 100 brings the input blocking unit 103 into a released state. The amplifying unit of each node waits for a main signal to be input. Upon receiving the main signal, the amplifying unit of each node operates using the target gain set in the ASE-employing activation operation as a control target value.

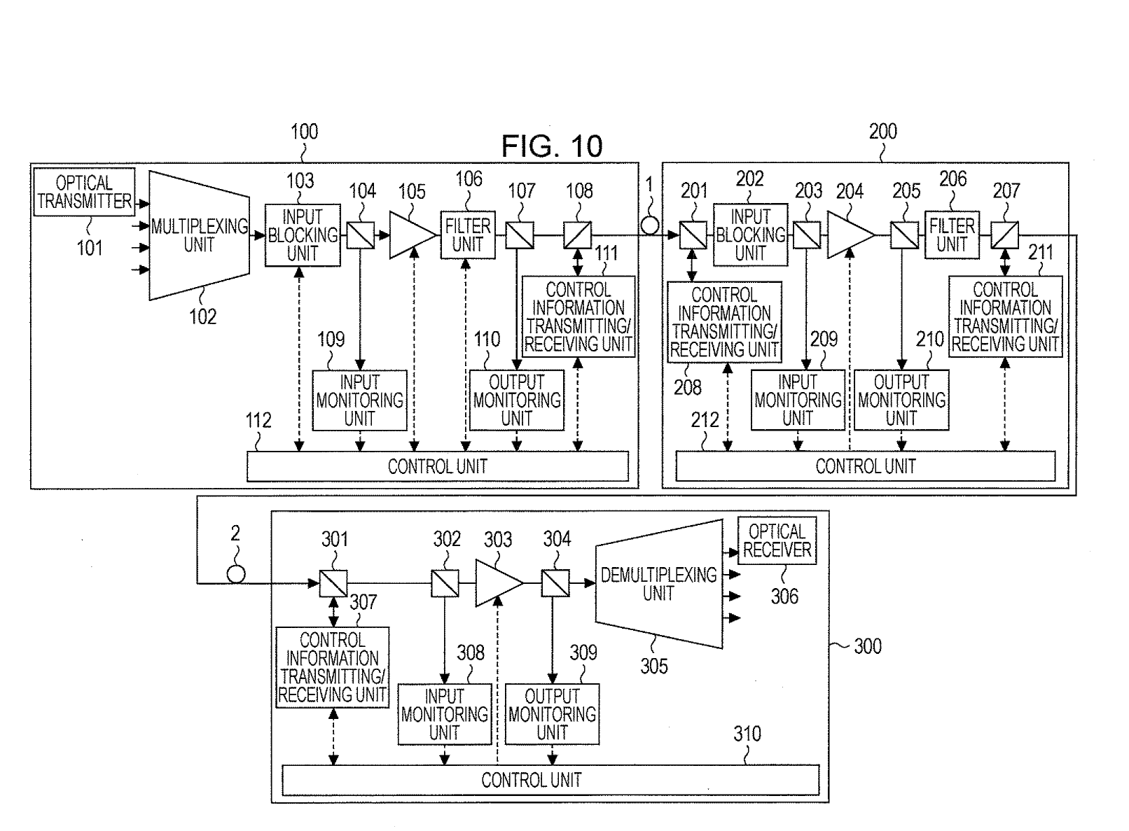

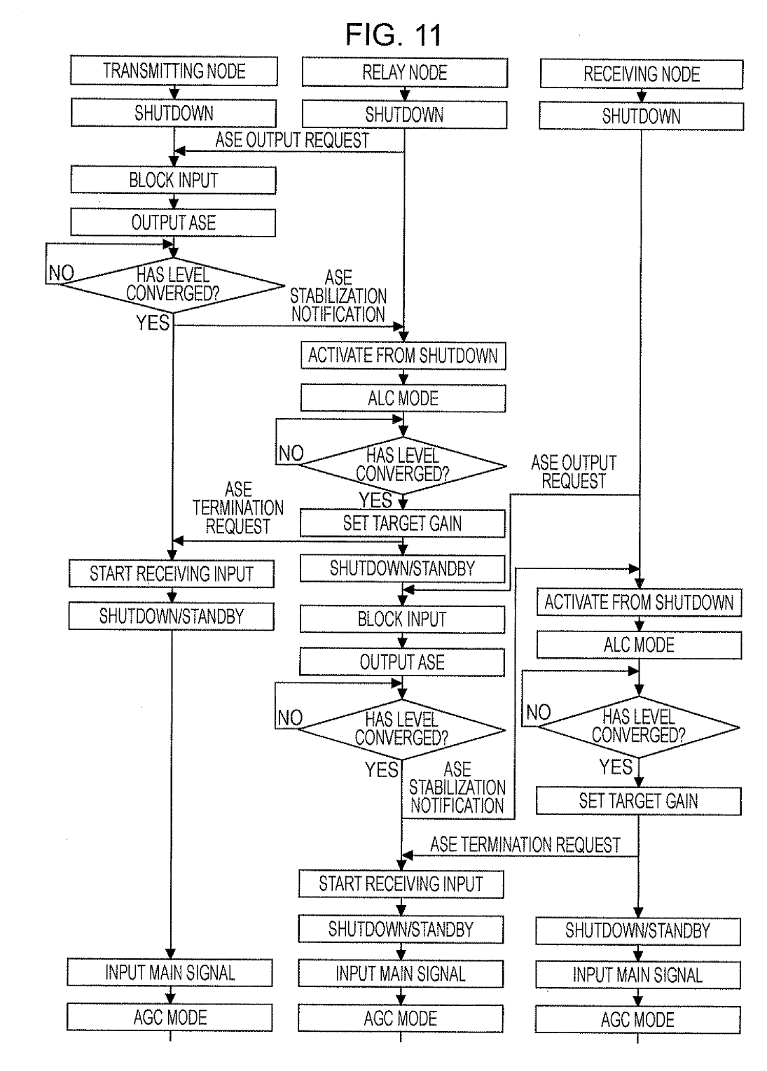

FIG. 10 is a diagram illustrating another configuration of an optical transmission system. As shown in FIG. 10, a relay node 200 includes an input blocking unit 202 on the input side of a relay amplifying unit 204. In addition, FIG. 11 is an explanatory diagram illustrating another example of a line activation process using ASE-employing activation. In the ASE-employing activation process shown in FIG. 9, the target gain used when the relay amplifying unit 204 and the receiving amplifying unit 303 operate in the AGC mode is set regarding multiple sections while setting the transmitting node 100 and other amplifying units to operate in the AGC mode and in the ALC mode, respectively. On the other hand, the ASE-employing activation method shown in FIG. 11, target gain of a reception-side amplifying unit is set while considering each relay section as one unit.

More specifically, the relay node 200 shown in FIG. 11 transmits an ASE output request to the transmitting node 100 on the upstream side. The transmitting node 100 brings the input blocking unit 103 into a blocked state. The transmitting node 100 then switches a mode of the transmitting amplifying unit 105 into the ASE mode. After stabilization of the ASE output, the transmitting node 100 transmits an ASE stabilization notification to the relay node 200. The relay node 200 sets a mode of the relay amplifying unit 204 to the ALC mode. After the output converges to a predetermined power level, the relay node 200 sets the target gain. The relay node 200 then transmits an ASE termination request to the transmitting node 100. Upon receiving this request, the transmitting node 100 brings the input blocking unit 103 into a released state. The transmitting node 100 then sets the mode of the transmitting amplifying unit 105 to an input standby state. At this time, activation of a line between the transmitting node 100 and the relay node 200 has completed.

A line between the relay node 200 and the receiving node 300 is then activated in a similar manner. The receiving node 300 transmits the ASE output request to the relay node 200. Upon receiving this request, the relay node 200 sets the mode of the relay amplifying unit 204 to the ASE mode. After stabilization of the output power, the relay node 200 transmits the ASE stabilization notification to the receiving node 300. The receiving node 300 sets the mode of the receiving amplifying unit 303 to the ALC mode. The receiving node 300 performs a control operation so that the power level monitored by the output monitoring unit 309 reaches to a predetermined value. The receiving node 300 sets target gain after convergence of the power level. After the compression of the gain setting, the receiving node 300 transmits the ASE termination request to the relay node 200. The relay node 200 sets the mode of the relay amplifying unit 204 to the input standby state.

In the above-described procedure, the gain is not necessarily set from the upstream sections. However, the relay node 200 is either on the transmission or reception side during the activation of each section and a sequence in which the relay node 200 transmits the ASE output request during setting of gain in the amplifying unit of the following node is not employed.

As described above, an optical amplifying device according to the embodiments creates a pseudo main signal from amplified spontaneous emission by applying a filter for removing signals in a non-main-signal band to the amplified spontaneous emission. In addition, in an optical transmission system according to the embodiments, a transmitting node and/or a relay node outputs a pseudo main signal, and the relay node and/or a receiving node calculates gain necessary for compensating a path loss. Accordingly, the accuracy of gain setting is improved by accurately calculating the path loss in the ASE-employing activation operation and the system activation speed can be increased.

Meanwhile, the configurations shown in the embodiments are only exemplary. The embodiments can be carried out while altering the embodiments appropriately. For example, an optical filter shown in the embodiments may be a filter having a characteristic for passing main signals and for removing signals in the other extra band. For example, a Fabry-Perot filter or a wavelength interference filter can be employed. In addition, the filter has to have the characteristic only during the ASE-employing activation operation and does not have to function as a filter during a normal operation. Furthermore, the input blocking unit has to simply block the input to the amplifying unit. For example, an optical attenuator or a device such as an optical switch can be employed.

In addition, in the ASE-employing activation method according to the embodiments, it is assumed that an optical amplifier that operates in the AGC mode as an initial operation mode selected when the relay amplifier and the receiving amplifier receive the main signal is employed. However, for example, the ASE-employing activation method can be applied to an optical amplifier that operates in the ALC mode instead of the AGC mode during a steady state.

An optical amplifying device according to the embodiments outputs amplified spontaneous emission, from which optical signals in a non-main-signal band is removed, as a pseudo input signal. In an optical transmission system employing this optical amplifier as a transmitting node and/or a receiving node, the relay amplifier and/or the receiving amplifier receive the pseudo input signal and sets target gain in the ALC mode. This allows target gain for a path loss of the main signal band to be set, which permits more accurate gain setting. As a result, an optical amplifying device and an optical transmission system realizing shortening of a line activation time can be advantageously obtained.

In addition, by using different output paths at the time of the ASE-employing activation operation and a normal operation, an optical amplifying device and an optical transmitting system that increase the line activation speed while suppressing the output loss caused during the normal operation can be advantageously obtained.

Furthermore, by providing a blocking unit for blocking a signal input to an amplifying unit during an operation in the ASE mode, an optical amplifying device and an optical transmission system that calculate a path loss more accurately can be advantageously obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical amplifying device comprising:
an amplifying unit amplifying an optical signal using stimulated emission;
a filter unit attenuating at least part of a band of an output of the amplifying unit other than a main signal band of the optical signal; and
an amplification control unit controlling the amplifying unit based on an output of the filter unit, the amplification control unit having an amplified spontaneous emission output mode for causing the amplifying unit to operate without requiring the optical signal to be input to the amplifying unit, and for causing the filter unit to filter an amplified spontaneous emission output from the amplifying unit and to output the filtered amplified spontaneous emission.

2. The device according to claim 1, wherein, in the amplified spontaneous emission output mode, the amplification control unit controls the amplifying unit so that the output of the filter unit indicates a specified value.

3. The device according to claim 1, comprising:
a direct output path allowing the output of the amplifying unit to be output without passing through the filter unit,
wherein the amplification control unit allows the output of the amplifying unit to be output using the direct output path when the optical signal is input to the amplifying unit, and the amplification control unit allows the output of the amplifying unit to be output through the filter unit in the amplified spontaneous emission output mode.

4. The device according to claim 1, comprising:
an input blocking unit blocking a signal from being input to the amplifying unit,
wherein the amplification control unit controls the input blocking unit to block the signal from being input to the amplifying unit in the amplified spontaneous emission output mode.

5. The device according to claim 1, wherein, when the optical signal is input to the amplifying unit, the amplification control unit selects one of an automatic level control mode for controlling an amplified output level to be constant and an automatic gain control mode for controlling amplification gain to be constant, and controls the amplifying unit using the selected mode.

6. An optical transmission system, comprising:
a transmitting node amplifying and transmitting an optical signal,
the transmitting node including:
an amplifying unit amplifying the optical signal using stimulated emission,
a filter unit attenuating at least part of a band of an output of the amplifying unit other than a main signal band of the optical signal, and
an amplification control unit controlling the amplifying unit based on an output of the filter unit, the amplification control unit having an amplified spontaneous emission output mode for causing the amplifying unit to operate without requiring the optical signal to be input to the amplifying unit, and for causing the filter unit to filter an amplified spontaneous emission output from the amplifying unit and to output the filtered amplified spontaneous emission; and
a receiving node receiving and amplifying the optical signal transmitted from the transmitting node in a amplifying unit of the receiving node, the receiving node having, as amplification control modes, an automatic level control mode for controlling an amplified output level to be constant and an automatic gain control mode for controlling amplification gain to be constant;
wherein control information is transmitted and received between the transmitting node and the receiving node, and
when a line is activated in the optical transmission system, the transmitting node and the receiving node operate in the amplified spontaneous emission output mode and the automatic level control mode, respectively, to set a target gain of the amplifying unit of the receiving node using the amplified spontaneous emission from which extra optical signals in a non-main-signal band are removed.

7. The system according to claim 6, comprising:
a relay node that exists between the transmitting node and the receiving node, amplifies and relays the optical signal, and relays the control signal,
the relay node including:
an amplifying unit amplifying an optical signal received from a preceding stage using stimulated emission,
a filter unit attenuating at least part of a band of an output of the amplifying unit other than a main signal band of the optical signal, and
an amplification control unit controlling the amplifying unit based on a output of the filter unit, the amplification control unit having, as amplification control modes, an amplified spontaneous emission output mode for causing the amplifying unit to operate without requiring the optical signal to be input to the amplifying unit, and for causing the filter unit to filter an amplified spontaneous emission output from the amplifying unit and to output the filtered amplified spontaneous emission, an automatic level control mode for controlling an amplified output level to be constant, with the optical signal being input, and an automatic gain control mode for controlling amplification gain to be constant, with the optical signal being input,
wherein, when the line is activated in the optical transmission system, the transmitting node operates in the amplified spontaneous emission output mode and the relay node and the receiving node operate in the automatic level control mode to set the gain of the relay node and the receiving node sequentially from upstream sections.

8. The system according to claim 6, comprising:
a relay node that exists between the transmitting node and the receiving node, amplifies and relays the optical signal, and relays the control signal,
the relay node including:
an amplifying unit for amplifying an optical signal received from a preceding stage using stimulated emission,
a filter unit for attenuating at least part of a band of an output of the amplifying unit other than a main signal band of the optical signal, and
an amplification control unit for controlling the amplifying unit based on a output of the filter unit, the amplification control unit having, as amplification control modes, an amplified spontaneous emission output mode for causing the amplifying unit to operate without requiring the optical signal to be input to the amplifying unit, and for causing the filter unit to filter an amplified spontaneous emission output from the amplifying unit and to output the filtered amplified spontaneous emission, an automatic level control mode for controlling an amplified output level to be constant, with the optical signal being input, and an automatic gain control mode for controlling amplification gain to be constant, with the optical signal being input,
wherein, when the line is activated in the optical transmission system, an upstream-side node and a downstream-side node of each relay section operate in the amplified spontaneous emission output mode and the automatic level control mode, respectively, to set a target gain used when the downstream-side relay node or the downstream-side receiving node operates in the automatic gain control mode.

9. The system according to claim 6, wherein the amplification control unit controls the amplifying unit so that an output obtained in the amplified spontaneous emission output mode becomes equal to a value equivalent to an output obtained in response to an input of a predetermined number of multiplexed optical signals so as to set gain of the relay node and/or the receiving node.

10. The system according to claim 9, wherein a value indicating the predetermined number is transmitted and received as the control information.
